(19) United States
(12) Patent Application Publication
(10) Pub. No.: US 2022/0315405 A1
(43) Pub. Date: Oct. 6, 2022

(54) BOTTLE OPENER

(71) Applicant: Danping LIU, Shenzhen, Guangdong (CN)

(72) Inventor: DANPING LIU, Shenzhen City, Guangdong Province (CN)

(21) Appl. No.: 17/608,751

(22) PCT Filed: Oct. 25, 2019
(86) PCT No.: PCT/CN2019/113298

§ 371 Date: Nov. 3, 2021

(51) Int. Cl. B67B 7/08

(52) U.S. Cl. CPC B67B 7/08

(57) ABSTRACT

A bottle opener, comprising a cover, an inflating device, and a shell sleeved outside the inflating device. A valve plug assembly comprises a valve plug base, a valve plug, and a valve plug stopper. The outer wall of the rear end of an inner inflating tube is sleeved with a piston ring, and the outer wall of the top end thereof is sleeved with a stop component. The inner inflating tube is provided with a first through hole. An inflating needle passes through the first through hole and is fixed in the through hole. The cover is connected to the shell. This device opens a wooden cork by means of air pressure, thereby effectively protecting the integrity of the wooden cork and improves the tightness of the wooden cork during repeated use. The bottle opener is convenient to carry, avoids scratching, and achieves a protection effect.

### FIELD OF THE INVENTION

The present invention relates to the field of a tool for opening a bottle, and particularly relates to a bottle opener.

### BACKGROUND OF THE INVENTION

A corkscrew is a tool for drawing corks from wine bottles. Common types of the corkscrew include: a hippocampus corkscrew, a rabbit corkscrew, a spiral corkscrew and so on. However, a hippocampus corkscrew or a rabbit corkscrew is used to open the wine bottle, wood slag of the cork easily falls into the red wine; and if the cork is used again, the sealing performance becomes poor, which causes the wine to deteriorate. On the other hand, a spiral corkscrew makes its auger exposed with a tip thereof easily stabbing the user, which causes a safety problem.

### BRIEF SUMMARY OF THE INVENTION

### Technical Problem

A main object of the present invention is to provide a bottle opener to solve the problems that the existing corkscrew easily causes wood slag of the cork falling into the red wine, a sealing performance of the second-use cork is poor, which causes the wine to deteriorate; and the existing corkscrew causes a safety problem.

### Technical Solutions

A bottle opener provided in the present invention comprises a bottom cover, an inflating device, and a shell sleeved outside the inflating device; the inflating device further comprises: an inflating needle, an inner inflating tube, a valve plug assembly, and an outer inflating tube which is sleeved outside the inner inflating tube; the valve plug assembly further comprises: a valve plug base, a valve plug, and a valve plug stopper; the valve plug base is connected with the valve plug stopper, and defines a first chamber therein; the valve plug is arranged in the first chamber; an outer wall of a head end of the inner inflating tube is sleeved with a piston ring; an outer wall of an end of the inner inflating tube is sleeved with a stop component for limiting a movement of the outer inflating tube; the inner inflating tube defines a first through hole therein, the inflating needle is fixed in and passes through the first through hole; and the bottom cover is connected to the shell.

Herein, the inner inflating tube defines a second chamber therein; the outer inflating tube and the inner inflating tube are connected by the stop component and form a third chamber therebetween; the head end of the inner inflating tube is equipped with the valve plug assembly therein to close airflow out of the second chamber, and the stop component is embedded in the outer wall of the inner inflating tube.

Herein, one end of the stop component forms an externally-threaded cylinder; an internally-threaded groove is fitted in the bottom cover and is coupled to the externally-threaded cylinder of the stop component.

Herein, the outer wall of the head end of the inner inflating tube forms an annular groove adapted to the piston ring, and the piston ring is sleeved in the annular groove.

Herein, the valve plug base has a second through hole; an inner wall of the valve plug base forms a step that is engaged with the valve plug stopper; one end of the valve plug stopper forms a protrusion; the protrusion forms a plurality of lateral openings.

Herein, the valve plug has a conical shape.

Herein, the inner wall of the head end of the inner inflating tube is provided with a first limiting groove for limiting the valve plug base.

Herein, the outer inflating tube is embedded in the shell to form a second limiting groove movably engaged with the stop component.

Herein, the bottom cover is provided with a fourth chamber for accommodating the inflating needle.

Herein, the bottom cover and the shell are made of wood materials.

### Advantages

The bottle opener of the present invention includes a bottom cover, an inflating device, and a shell sleeved outside the inflating device, the valve plug assembly includes a valve plug base, a valve plug, and a valve plug stopper. The valve plug base is connected with the valve plug stopper and forms a first chamber therein, the valve plug is arranged in the first chamber, the outer wall of the head end of the inner inflating tube is sleeved with a piston ring, and the outer wall of the end of the inner inflating tube is sheathed with a stop component for the movement of the outer inflating tube. Therefore, when using the bottle opener, pulling up the outer inflating tube, the air pressure in the chamber of the inner inflating tube and the chamber of the inflating needle becomes in a negative pressure state; the valve plug will move to close the valve plug base to prevent air flowing out of the inner inflating tube so as to seal the same. When the outer inflating tube is pressed down, the space between the inner inflated tube and the outer inflated tube is compressed, the air pressure in the space is increased, the piston ring is pressed against the tube wall of the inner inflating tube to seal, the air flows into the inflating needle from the inner inflating tube, air is continuously input into the bottle, the air pressure in the bottle rises, and the cork is continuously pushed upward under the action of the air pressure. When the bottle opener is not in use, just insert the inflating needle of the inflating device into the bottom cover and lock it by threads, which is convenient to carry, prevents scratches, and has a protective effect. This bottle opener pulls up a wooden cork by means of air pressure, thereby effectively protecting the integrity of the wooden cork and improves the tightness of the wooden cork during repeated use. The bottle opener is convenient to carry, avoids scratching, and achieves a protection effect.

### BRIEF DESCRIPTION OF THE DRAWINGS

FIG. 1 is a schematic structural diagram of a bottle opener provided in accordance with an embodiment of the present invention;

FIG. 2 is a schematic diagram of the inflating device of the bottle opener in accordance with the embodiment of the present invention;

FIG. 3 is a cross-sectional view of a bottom cover of the bottle opener in accordance with the embodiment of the present invention;

FIG. 4 is a cross-sectional view of the bottle opener in a use state in accordance with the embodiment of the present invention;

FIG. 5 is a schematic diagram of the bottle opener in a use state in accordance with the embodiment of the present invention;

FIG. 6 is a schematic diagram of a close state of the bottle opener in accordance with the embodiment of the present invention;

FIG. 7 is a schematic diagram of a stop component of the bottle opener in accordance with the embodiment of the present invention;

FIG. 8 is a schematic structural diagram of a valve plug assembly of the bottle opener in accordance with the embodiment of the present invention; and

FIG. 9 is a cross-sectional view of the valve plug assembly of the bottle opener in accordance with the embodiment of the present invention.

### DETAILED DESCRIPTION OF THE INVENTION

In order to make the purpose, technical solutions, and advantages of the present invention clearer, the following further describes the present invention with reference to the accompanying drawings and detail embodiments. It should be understood that the specific embodiments described here are only used to explain the present invention, and are not used to limit the present invention.

In order to illustrate the technical solutions of the present invention, detail embodiments are described below.

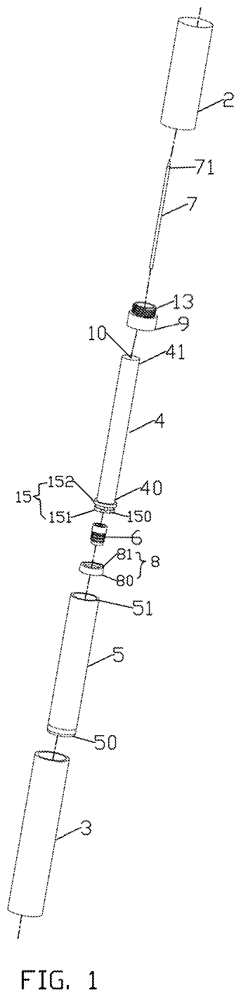

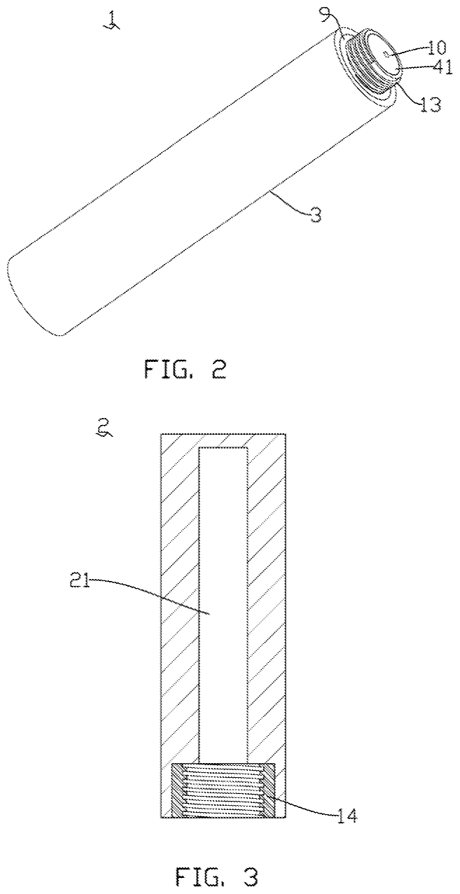

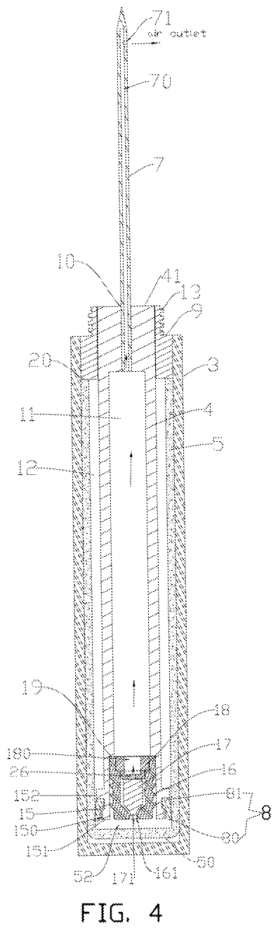

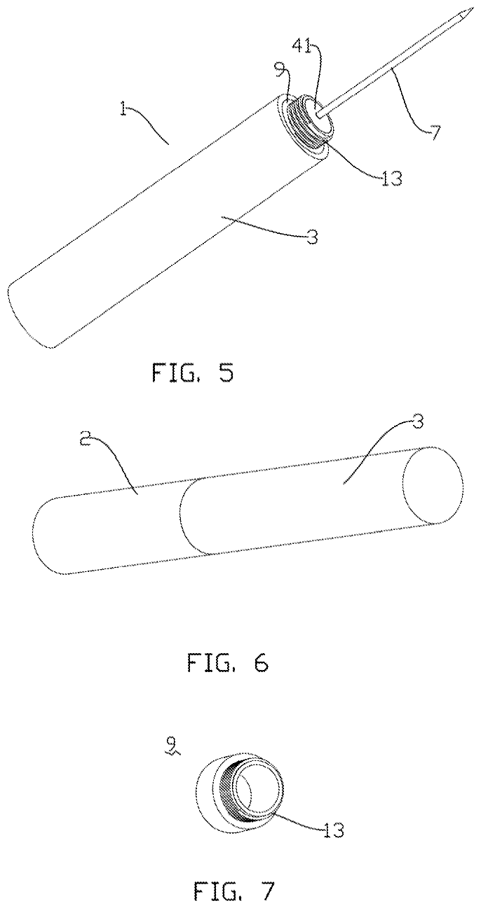

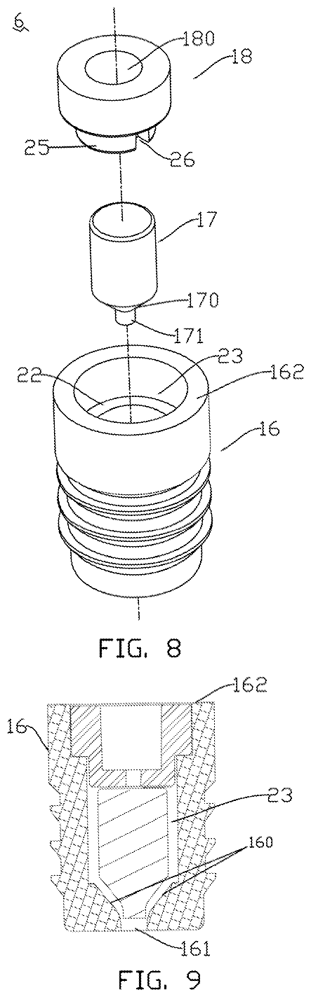

Referring to FIGS. 1-9, a bottle opener provided in accordance with an embodiment of the present invention comprises: a bottom cover 2, an inflating device 1, and a shell 3 sheathed outside the inflating device. The inflating device 1 comprises: an inflating needle 7, an inner inflating tube 4, a valve plug assembly 6, and an outer inflating tube 5 sleeved outside the inner inflating tube. The valve plug assembly 6 comprises: a valve plug base 16, a valve plug 17 and a valve plug stopper 18. The valve plug base 16 is connected with the valve plug stopper 18, forms the first chamber 23. The valve plug 17 is disposed in the first chamber 23. An outer wall of the head end of the inner inflating tube 4 is sleeved with a piston ring 8, and an outer wall of the end of the inner inflating tube 4 is fitted in a stop component 9 which is used for limiting the movement of the outer inflating tube 5. The inner inflating tube 4 defines the first through hole 10, and the inflating needle 7 is fixed in and pass through the first through hole 10. The bottom cover 2 and the shell 3 can be connected.

In the embodiment of the present invention, the inner inflating tube 4 defines the second chamber 11. The outer inflating tube 5 and the inner inflating tube 4 can be connected at the stop component 9 to define a third chamber 12 therebetween. The head end of the inner inflating tube 4 therein is equipped with the valve plug assembly 6 which can be used for closing the second chamber 11 to prevent air from flowing out, and the stop component 9 is embedded in the outer wall of the inner inflating tube 4.

In the embodiment of the present invention, the stop component 9 is a cylinder and forms an externally-threaded cylinder 13 at the end thereof, and the bottom cover 2 is fitted therein with an internal-threaded groove 14 which is coupled to the externally-threaded cylinder 13 of the stop component. The outer wall of the head end of the inner inflating tube 4 forms an annular groove 15 and the piston ring 8 is fitted in the annular groove 15. The piston ring 8 is sleeved in the annular groove 15. When the space between the inner inflating tube 4 and the outer inflating tube 5 is compressed, air pressure in the space is increased, the piston ring 8 is used to tightly fit on to seal the outer wall of the inner inflating tube 4.

In the embodiment of the present invention, the valve plug assembly 6 includes a valve plug base 16, a valve plug 17, and a valve plug stopper 18. The inner wall of the head end of the inner inflating tube 4 therein defines a first limiting groove 19 for limiting the valve plug base 16. The function of the valve plug assembly 6 is that: when pressing the outer inflating tube 5 of the inflating device 1 for inflation, the valve plug opens thus air enters the wine bottle through the inflating needle. When the outer inflating tube of the inflating device is pulled off, the valve plug moves to the valve plug base until the valve plug 17 tightly fits on and seals the tapered inner wall in the valve plug base, so that air cannot flow out.

In the embodiment of the present invention, the valve plug base 16 has a second through hole 24, and the inner wall of the valve plug base 16 is provided with a step 22 that is used for engaging with the valve plug stopper 18. One end of the stopper 18 forms a protrusion 25, and the protrusion 25 forms lateral openings 26. The shape of the valve plug 17 is conical.

In the embodiment of the present invention, the inner wall of the head end of the inner inflating tube 4 is provided with a first limiting groove 19 for limiting the valve plug base 16.

In the embodiment of the present invention, the outer inflating tube 5 is embedded in the shell 3 and form a second limiting groove 20, and movably matches with the stop component 9.

In the embodiment of the present invention, the bottom cover 2 defines a fourth chamber 21 therein for accommodating the inflating needle 7, and the fourth chamber 21 is used for accommodating the inflating needle 7 to protect the inflating needle from being exposed to hurt the user or cause other disadvantages.

In the embodiment of the present invention, the bottom cover 2 and the shell 3 are made of wood materials, which improves the appearance of the bottle opener.

The working process of the bottle opener provided in the embodiment of the present invention is as follows:

when in use, pulling the outer inflating tube, the air pressure in the inner inflating tube and the inflating needle becomes in a negative pressure state; and the valve plug moves to fit against the valve plug base. When pressing the outer inflating tube 5, the space between the inner inflating tube and the outer inflating tube is compressed, the air pressure in the space is increased, the piston ring 8 can tightly fit and seal the tube walls between the inner inflating tube; the air flows into the inflating needle through the inner inflating tube and air is continuously input into the wine bottle. As the air pressure in the wine bottle being increased, the cork will be pushed upward under the action of air pressure; finally, the cork can be pulled out under the air pressure in the wine bottle, and an integrate and unbroken cork can be easily obtained.

When not in use, inserting the head of the inflating needle into the fourth chamber of the bottom cover, and the cylinder of the stop component of the inflating device and the groove of the bottom cover are screwed to facilitate carrying.

In accordance with the embodiments of the present invention, the bottle opener pulls out a wooden cork of the wine bottle by means of air pressure, thereby effectively protecting the integrity of the wooden cork and improving the sealing performance of the wooden cork during repeated use. The bottle opener is convenient to carry and avoids hurting the user so as to provide a saft protection.

The above descriptions are only preferred embodiments of the present invention, and are not intended to limit the present invention. Any modification, equivalent replacement and improvement made within the spirit and principle of the present invention shall be included within the scope of the present invention.

1. A bottle opener, comprising an inflating device, wherein the inflating device further comprises:
a hollow inflating needle used to pierce a cork to inflate a bottle;
an inner inflating tube used to fix the hollow inflating needle and input air into the hollow inflating needle;
a piston ring;
a valve plug assembly disposed in the inner inflating tube for opening or closing airflow into the inner inflating tube; and
an outer inflating tube;
wherein the piston ring is movably sleeved around an outer wall of a rear open end of the inner inflating tube and is used for sealing or unsealing a space between the inner inflating tube and the outer inflating tube; the outer inflating tube is movably sleeved outside the inner inflating tube for drawing external air into said space or compressing air in said space to flow into the inner inflating tube.

2. The bottle opener of claim 1, wherein the inner inflating tube has a chamber in air flow communication with the hollow inflating needle; the outer inflating tube and the inner inflating tube are connected by the piston ring and form said space therebetween; the rear open end of the inner inflating tube is tightly equipped with the valve plug assembly therein to close or open airflow into the inner inflating tube.

3. The bottle opener of claim 11, wherein a top end of the annular stop component forms an externally-threaded cylinder head; the bottle opener further comprises a cover; an internally-threaded ring is tightly fitted in the cover and is coupled to the externally-threaded cylinder head of the annular stop component.

4. The bottle opener of claim 1, wherein the outer wall of the rear open end of the inner inflating tube forms an annular groove adapted to the piston ring; and the piston ring is moveably sleeved in the annular groove; the annular groove is located between an upper annular flange and a lower flange which are used to limit the piston ring moving therebetween; one or more notches are formed on the outer wall of the rear open end of the inner inflating tube across the annular groove and the lower flange for connecting air flow between outside and inside of said space; the piston ring has an annular top flange moveably limited in the annular groove and a lower edge spaced from the outer wall of the inner inflating tube; in a state where the piston ring moves up under an increased air pressure in said space generated by pressing the outer inflating tube, the annular top flange of the piston ring is capable of tightly fitting under the upper annular flange of the annular groove when the, the lower edge of the piston ring is capable of tightly fitted on an inner wall of the outer inflating tube, whereby said piston ring seals said space; in a state where piston ring moves downwards under a negative air pressure in said space by pulling the outer inflating tube, the annular top flange of the piston ring exposes the one or more notches for connecting air flow between outside and inside of said space.

5. The bottle opener of claim 11, wherein an inner wall of the valve plug base forms a step that is engaged with the valve plug stopper; a rear end of the valve plug stopper forms a protrusion; the protrusion forms one or more lateral openings which are in airflow communication with the through hole of the valve plug stopper; the valve plug base is tightly fitted in the inner inflating tube, and the valve plug stopper is tightly fitted in the valve plug base.

6. The bottle opener of claim 11, wherein the valve plug has a conical shape with a tapered rear end and a plug tip extending rearwards; a rear end of the chamber of the valve plug base forms a tapered inner wall to connect with the air nozzle; the valve plug assembly is used to close the airflow into the inner inflating tube when the valve plug moves down to the valve plug base with the tapered rear end tightly fitting and seals on the tapered inner wall and the plug tip extending in the air nozzle; or, the valve plug assembly is used to open the airflow into the inner inflating tube when the valve plug moving up away the valve plug base with the tapered rear end and the tapered inner wall being separated.

7. The bottle opener of claim 11, wherein the inner wall of the rear end of the inner inflating tube is provided with a limiting groove for fixing the valve plug base.

8. The bottle opener of claim 11, wherein the bottle opener further comprises a shell sleeved outside the inflating device; the outer inflating tube is tightly embedded in the shell to form a limiting groove engaged with the annular stop component; the shell is made of wood materials.

9. The bottle opener of claim 3, wherein the cover is provided with a chamber for accommodating the hollow inflating needle.

10. The bottle opener of claim 3, wherein the cover is made of wood material.

11. The bottle opener of claim 1, wherein the valve plug assembly further comprises:
a valve plug base which defines a chamber therein and forms a top open end and an air nozzle in a rear end for air of the valve plug base for air flow;
a valve plug; and
a valve plug stopper with a through hole therein in air flow communication with the inner inflating tube and the valve plug base;
wherein the valve plug base is connected with the valve plug stopper; the valve plug is movably arranged in the chamber for opening or closing the air nozzle so as to open or close airflow to the inner inflating tube; an outer wall of a top end of the inner inflating tube is tightly sleeved with an annular stop component for limiting a movement of the outer inflating tube.

12. The bottle opener of claim 11, wherein the inner inflating tube defines a through hole in a top end thereof, and the hollow inflating needle is fixed in and passes through the through hole of the inner inflating tube.
